(19) United States
(12) Patent Application Publication
(10) Pub. No.: US 2020/0323351 A1
(43) Pub. Date: Oct. 15, 2020

(54) TILTING MECHANISM

(71) Applicant: Anton Alekseevich ALTYNBAEV, Ufa (RU)

(72) Inventor: Anton Alekseevich ALTYNBAEV, Ufa (RU)

(21) Appl. No.: 16/090,698

(22) PCT Filed: Aug. 9, 2016
(86) PCT No.: PCT/RU2016/000525

§ 371 Date: Oct. 2, 2018

(30) Foreign Application Priority Data
Apr. 19, 2016 (RU) 2016114933

(51) Int. Cl. A47C 17/40; F16C 11/04

(52) U.S. Cl. CPC A47C 17/40; F16C 11/04

(57) ABSTRACT

A mechanism to improve the rotation smoothness of the transformer bed deck (folding bed/box bed) and to provide the balancing of the transformer bed deck. The above technical result is achieved in the rotation mechanism of the transformer bed that has an enclosure for mounting to the fixed part of the transformer bed, where the enclosure has a hinge-mounted lever for mounting to the movable part of the transformer bed, where the stretching elastic element and the compression elastic element are mounted with one end of each element inside the enclosure and are mounted with the other ends to the lever via the mounting axes, and where the enclosure has a split on it to guide the movement of the mounting axis of the compression elastic element.

The utility model refers to the consumer goods industry, particularly, to the rotation/lifting mechanism of the moving element (deck) of the bed from the horizontal position to vertical position, and vice versa (the mechanism of the double acting unit of the transformer bed), and is designed to be used in production and operation of the folding furniture such as the lifting/folding bed, wall bed, and box bed.

The rotation mechanism of the horizontal wall bed with the bracket for its mounting to the bed frame, the strip for the mechanism mounting to the fixed parts of the bed and SUSPA gas cylinder, connected to them (http://xn--80aclb4abb5agn9i.xn--p1ai/goods/Mehanizm-gorizontalnoj-shkaf-krovati-582, 2016) is known as the prior art.

The lifting mechanism is known for the wall beds that have a wrap springs block placed in the enclosure, an adjusting bolt for balancing the springs extension while in operation, and a strip which is fixed to the bed frame from one side and able to rotate on the enclosure on the other side, wherein the strip is made with the raised face that engages the bow-shaped gutter connected to the springs block, and the enclosure is made as an assembly, its two parts are clamped together with a metal staple (https://www.youtube.com/watch?v=SFmSODv6l6A&ebc=ANyPxKrGlaeJmUb3HBDALOvHSkm8s6R7QAhdtvLfuMrVBKb4xzS1QB-laUSxT6M1sFwORK5x1lxLXfXMD3mh- FpwvGXaxLJPOQ, 2013, http://www.wallbed.ru/mm.html). This mechanism can be considered as the closest analogue.

The technical problem that this utility model is aimed to solve consists in creating a transformer bed lifting mechanism with the parameters and characteristics that provide the improvement of the technology during the manufacturing, maintenance, repair and/or operation, its design in comparison with the known analogues, and easier transformation of the bed from its vertical position into the horizontal and vice versa.

The technical result achieved by the implementation of this utility model lies in the improved rotation smoothness of the transformer bed deck (folding bed/box bed) and the provided balancing of the transformer bed weight.

The above technical result is achieved in the rotation mechanism of the transformer bed that has an enclosure for mounting to the fixed part of the transformer bed, wherein the enclosure has a hinge-mounted lever on it for mounting to the movable part of the transformer bed, and the stretching elastic element and the compression elastic element mounted inside the enclosure with one end of each elastic element and mounted to the lever via mounting axes with other ends, wherein the enclosure has a split for passing of the mounting axis of the compression elastic element.

The stretching elastic element is a spring.

The compression elastic element is a gas cylinder or a compression spring with properly sealed end coils of the spring.

The lever is an L-shape swivel plate with bores for mounting to the movable parts of the transformer bed.

The lever is fixed on the enclosure with a rotation axis, which is an axle box fixed on the enclosure and into the axial bore of which a mating spindle, which is fixed to the lever, engages.

The claimed design of the transformer bed rotation mechanism provides the rotation smoothness of the transformer bed deck (folding bed) and balancing of the deck weight due to the possibility of the simultaneous action (combined action) of the stretching elastic element (spring) and compression elastic element (gas cylinder). Furthermore, this design provides the minimization of the mechanism dimensions, which, it its turn, minimizes the requirements for the sizes and design of the finished product (wall bed).

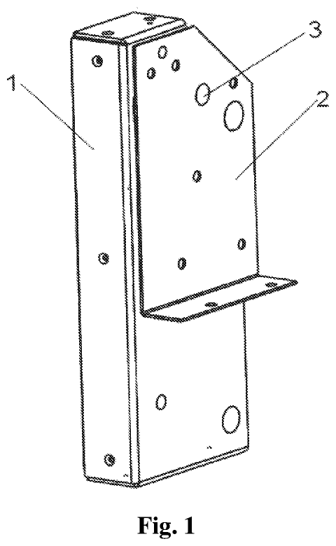

The principle of the utility model is explained by the drawings where FIG. 1 shows the external view of the transformer bed rotation mechanism in its folded state (the folded state means both the state of the rotation mechanism for storage and transportation and the folded state of the transformer bed—the deck is lifted up);

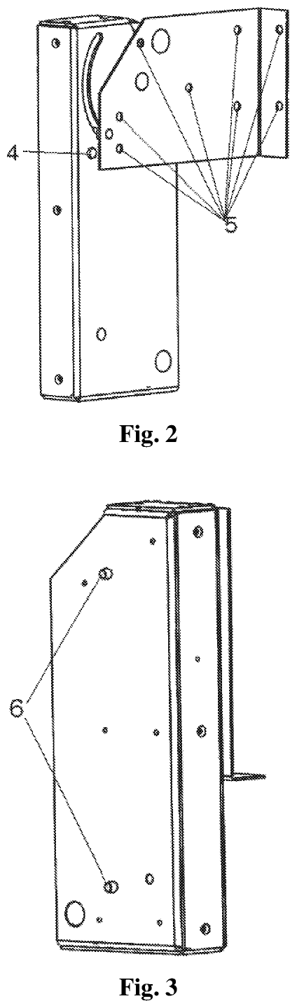

FIG. 2—the external view of the transformer bed rotation mechanism in operation (the unfolded state of the transformer bed—the deck is down);

FIG. 3—the external view of the transformer bed rotation mechanism from the side of the base plate that is mounted to the fixed part of the transformer bed (outer enclosure);

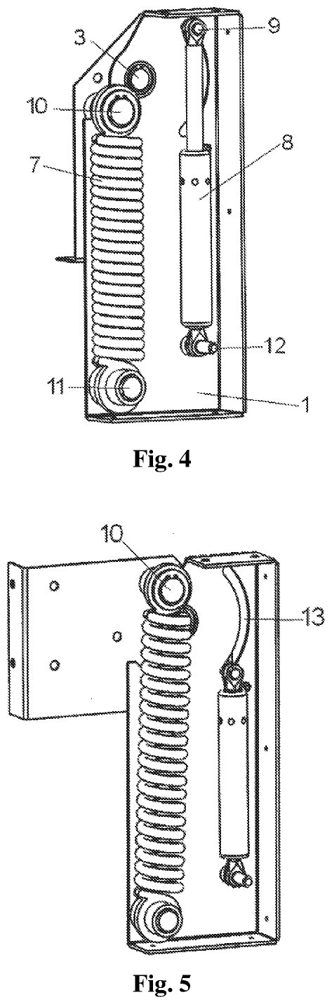

FIG. 4—the transformer bed rotation mechanism in the folded state without the base plate;

FIG. 5—the transformer bed rotation mechanism in operation without the base plate;

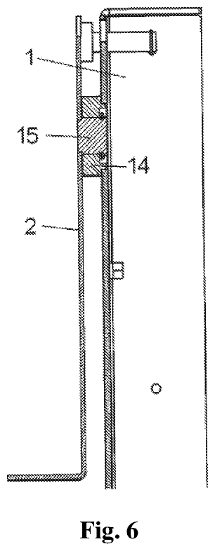

FIG. 6—the mounting of the mechanism rotation axis (sectional view).

The legend:

1—the enclosure (the fixed part or the cover plate),

2—the lever (the rotation part),

3—the lever rotation axis,

4—the mounting axis of the leg pull stud,

5—the bores for mounting to the movable part of the transformer bed (the mounting of the bed deck),

6—the positioning pins,

7—the stretching elastic element,

8—the compression elastic element,

9—the mounting axis of the stretching elastic element (8) to the lever (2),

10—the mounting axis of the stretching elastic element (7) to the lever (2),

11—the mounting axis of the stretching elastic element (8) to the enclosure (1),

12—the mounting axis of the compression elastic element (8) to the enclosure (1),

13—the split in the enclosure (1) through which the mounting axis (9) of the compression elastic element (8) to the lever (2) passes,

14—the axle box welded (press-fitted) or otherwise rigidly fixed to the enclosure (1).

15—the mating spindle rigidly fixed (welded, press-fitted) to the lever (2).

The rotation mechanism of the transformer bed consists of the enclosure (1), the lever (2) mounted with the ability to rotate around the rotation axis (3) on the enclosure (1) and representing an L-shaped swivel plate with the bores (5) for the mounting to the movable part of the transformer bed, the stretching elastic element (springs) (7), and the compression elastic element (gas cylinder) (8).

The position of the bores (5) on the lever (2) can vary, and the lever (2) can be fixed on the movable part/component (frame/deck/shell/carcass) of the transformer bed with the help of any fasteners (self-tapping screws, screw bolts, screw staves, etc.).

The enclosure is made of a base plate and a cover between which the (fixed) mounting axes (11, 12) of the stretching (7) and compression elastic elements (8) are mounted. The base plate and the cover are connected to each other with the screwed joints. The base plate is mounted to the fixed part of the transformer bed with self-tapping screws or any other standard fasteners (self-tapping screws, drywall screws, screw bolts).

The rotation axis (3) is made as the axle box (14) welded (press-fitted) or otherwise rigidly fixed to the enclosure cover (1), into the bore of which the mating spindle (15), which is welded (press-fitted) to the lever 2, engages.

The design of the lever (2) as an L-shaped swivel plate facilitates the installation of the deck (frame/shell/carcass) to the rotation mechanism of the transformer bed.

The stretching elastic element (7) is fixed with one end inside of the enclosure (1) with the help of the mounting axis (11) and fixed to the lever (2) with the other end via the mounting axis (10), wherein this end of the stretching elastic element (7) passes through the bore formed by the base plate and enclosure cover (1) in its folded state.

The compression elastic element (8) is fixed with one end inside of the enclosure (1) with the help of the mounting axis (12), and fixed to the lever (2) with the other end via the mounting axis (9), wherein there is the split (13) on the enclosure cover, along which the mounting axis (9) of the compression elastic element (8) moves.

The enclosure cover (1) can have the mounting axis (4) of the leg pull stud (it is a component of the finished product), its presence/absence does not influence the functionality of the rotation mechanism itself, and there can be at least one positioning pin (6) made on the enclosure base plate (1) facilitating the accurate installation of the rotation mechanism to the transformer bed (article) and bearing the weight of the deck (frame/shell/carcass).

The rotation mechanism is used in the following way.

Two rotation mechanisms are provided for one bed.

The enclosure of the rotation mechanism is mounted to the fixed part of the transformer bed, for example, serving as a wardrobe enclosure, and the lever of the rotation mechanism is mounted to the bed deck.

To modify the transformer bed (furniture), for example, the wall bed, from the “wall” position to the “bed” position, the deck is rotated with a force directed down and forwards to the user. The rotation mechanism is activated by shifting/rotation of the lever that impacts the stretching elastic element by stretching it and the compression elastic element by pushing the piston rod of the gas cylinder decreasing its total length, and the mounting axis (9) moves inside of the split in this case.

To return to the “wall” position, the reverse operations should be done. The deck should be rotated upside, and at the same time, the rotation mechanism is activated by shifting/rotation of the lever that is impacted by the stretching and compression elastic elements which constrict (tighten) and expand (push out) correspondingly to balance the weight of the deck and facilitate folding of the bed for the user by decreasing the applied efforts to the acceptable level (not more than 80 N). In this case, the mounting axes (9 and 10) rotate around the rotation axis of the lever (axis 9 moves inside of the split). The claimed rotation mechanism has a simple design, operational reliability, and usability.

1-5. (canceled)

6. A transformer bed rotation mechanism, comprising:
an enclosure for mounting to a fixed part of the transformer bed, on which a lever is hinge-mounted to a movable part of the transformer bed and inside of which stretching and compression elastic elements are mounted with one end of each element, wherein the stretching and compression elastic elements are mounted with other ends to a lever via mounting axes, wherein the enclosure has a split for passing of the mounting axis of the compression elastic element.

7. The transformer bed rotation mechanism of claim 6, wherein the stretching elastic element which is a spring.

8. The transformer bed rotation mechanism of claim 6, wherein the compression elastic element which is a gas cylinder or a compression spring.

9. The transformer bed rotation mechanism of claim 6, further comprising a lever which is an L-shaped swivel plate with bores for mounting to the movable part of the transformer bed.

10. The transformer bed rotation mechanism of claim 9, wherein the lever which is mounted on the enclosure with a rotation axis which is an axle box mounted on the enclosure and into an axial bore of which a mating spindle, which is fixed to the lever, engages.
